(19) United States
(12) Patent Application Publication
(10) Pub. No.: US 2006/0095234 A1
(43) Pub. Date: May 4, 2006

(54) Converting between coordinate systems

(76) Inventors: Cyril Brignone, Mountain View, CA (US); Salil Pradhan, Santa Clara, CA (US); Bill Serra, Montara, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/977,517

(22) Filed: Oct. 29, 2004

(51) Int. Cl. G06F 15/00

(52) U.S. Cl. 702/196

(57) ABSTRACT

In one embodiment of the present invention, a first set of coordinates for a plurality of locations in a symmetric environment is accessed. The first set of coordinates are defined by a position determining system disposed in the symmetric environment which uses a first coordinate system. A second set of coordinates for the plurality of locations in the symmetric environment are accessed. The second set of coordinates are defined by a second coordinate system. The first set of coordinates are correlated with the second set of coordinates. Then, at least one matrix is determined that is useable to convert a set of coordinates defined by the first coordinate system to a corresponding set of coordinates defined by the second coordinate system.

### TECHNICAL FIELD

Embodiments of the present invention relate to the field of networked electronic devices. Specifically, embodiments of the present invention relate to converting between different coordinate systems used by the networked electronic devices.

### BACKGROUND ART

It is becoming increasingly useful to establish a network of electronic devices that know their coordinates in a common coordinate system. For example, the network of electronic devices can be used to assist navigation through a building. Assume a person desires to locate a printer in a building. The user can locate the printer by navigating through the building with a hand-held device that displays a map of the building with the user's current position highlighted.

To assist in the navigation, a network of electronic devices can be placed throughout the building with each device's coordinates being known by that device and/or a back-end computing system. A map of the building with coordinates is developed, such that portions of the map can be displayed on a hand-held electronic device if the coordinates of the hand-held device are known. As a person holding the electronic device navigates through the building, the hand-held electronic device communicates with the other electronic devices to obtain its coordinates, such that the user's position in the building is displayed on the electronic device.

For the above and other purposes, it is useful for each electronic device to know its coordinate in the building. The well-known global positioning system (GPS) is not well suited for use inside of a building. Therefore, another means must be used to establish the coordinates of the various electronic devices in the building. One conventional technique of establishing these coordinates is for a person to physically take measurements to determine a device's coordinate, which is then programmed into the electronic device and/or a back-end server. This technique is not only tedious but is error prone. Moreover, if the position of the electronic device is altered, its coordinate must be updated. For example, one of the electronic devices could be a computer system, printer, etc., which is free to be moved.

Some techniques for establishing coordinates for electronic devices provide for a number of local coordinate systems within a building. For example, a local coordinate system is developed for each room. The system might also have a back-end server that uses its own coordinate system. Thus, the various devices in the network need to be able to understand how another coordinate system relates to its own coordinate system. For example, the back-end server may need to understand the how each of the local coordinate systems relates to its coordinate system, or a device in one room may need to understand how a coordinate system used in another room relates to its own.

Thus, a challenge for establishing a coordinate system for a network of electronic devices is conveniently coordinating a number of coordinate systems. Further, some techniques for relating coordinate systems have tedious and error prone manual steps that must be taken.

### DISCLOSURE OF THE INVENTION

In one embodiment of the present invention, a first set of coordinates for a plurality of locations in a symmetric environment is accessed. The first set of coordinates are defined by a position determining system disposed in the symmetric environment which uses a first coordinate system. A second set of coordinates for the plurality of locations in the symmetric environment are accessed. The second set of coordinates are defined by a second coordinate system. The first set of coordinates are correlated with the second set of coordinates. Then, at least one matrix is determined that is useable to convert a set of coordinates defined by the first coordinate system to a corresponding set of coordinates defined by the second coordinate system.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a diagram of an exemplary environment with coordinate systems illustrating principles in accordance with embodiments of the present invention.

FIG. 2 illustrates an exemplary device that may serve as a platform upon which to perform embodiments of the present invention.

FIG. 3 is a flowchart illustrating steps of a process of converting between coordinate systems in accordance with embodiments of the present invention.

FIG. 4A and FIG. 4B are diagrams of first and second coordinate systems illustrating principles of embodiments of the present invention.

FIG. 5A and FIG. 5B are diagrams illustrating exemplary matrices that are used in a process of converting between coordinate systems in accordance with embodiments of the present invention.

FIGS. 6A and FIG. 6B are diagrams illustrating a coordinate conversion process for an asymmetric environment, in accordance with embodiments of the present invention.

FIGS. 7A and FIG. 7B are diagrams illustrating orienting coordinate systems in a coordinate conversion process for an asymmetric environment, in accordance with embodiments of the present invention.

### DETAILED DESCRIPTION OF THE INVENTION

In the following detailed description of embodiments of the present invention, converting between coordinate systems, numerous specific details are set forth in order to provide a thorough understanding of the present invention. However, embodiments of the present invention may be practiced without these specific details or by using alternative elements or methods. In other instances, well known methods, procedures, components, and circuits have not been described in detail as not to unnecessarily obscure aspects of the present invention.

### Notation and Nomenclature

Some portions of the detailed descriptions that follow are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “accessing” or “correlating” or “establishing” or “repeating” or “communicating” or “basing” or “calculating” or “determining” or “selecting” or “matching” or “displaying” or “relating” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### Converting Between Coordinate Systems

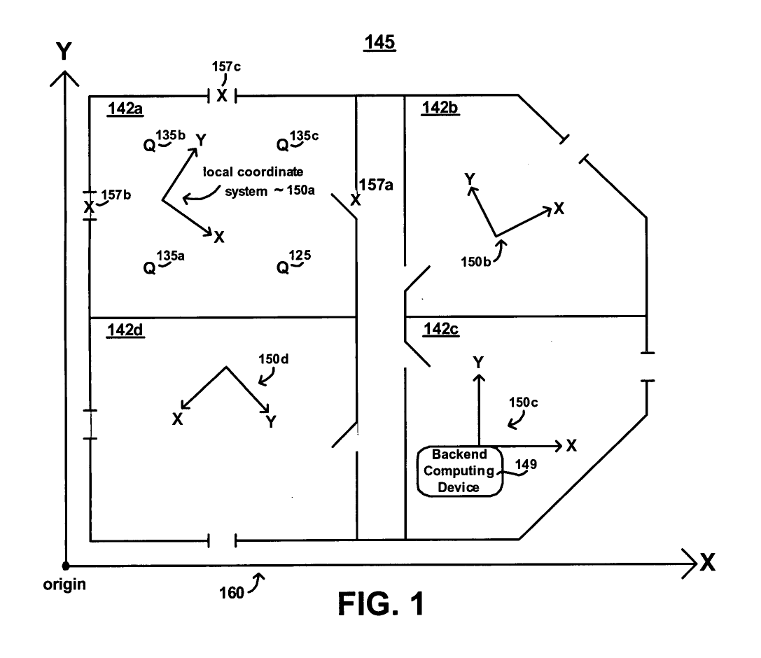

Embodiments of the present invention are applicable to converting between a first coordinate system and a second coordinate system. For convenience of explanation an example is provided in which the first coordinate system is referred to as a local coordinate system and the second coordinate system is referred to as a common coordinate system. For example, FIG. 1 depicts an exemplary building with a local coordinate system for each room and a common coordinate system for the overall building. However, embodiments of the present invention are not limited to converting between coordinate systems that are deemed local and/or common.

FIG. 1 depicts an exemplary building 145 with rooms 142a-142d. Typically, embodiments of the present invention are applied to regions in which the global positioning system (GPS) is not suitable, such as within a building. However, there is no requirement that GPS or any other positioning system be unsuitable in order for an embodiment of the present invention to be applicable.

A local coordinate system 150 may be a coordinate system that has already been developed for a single room 142 or other region of a building 145. For example, each room 142a-142d in the exemplary building 145 has its own local coordinate system 150a-150d. A local coordinate system 150 is defined by an origin and two axes, in this embodiment. However, in other embodiments, the local coordinate system 150 has either one or three axes. The axes may be at any orientation. Further, the origin of a local coordinate system (e.g., 150a) may be in any location and need not be in the room (e.g., 142a) for which the local coordinate system is typically used. It will be understood that multiple rooms 142 may use the same local coordinate system 150. Further, a single room 142 may have multiple local coordinate systems 150.

Still referring to FIG. 1, the common coordinate system 160 might be a coordinate system that has already been developed for the entire building 145. In this case, the common coordinate system 160 is oriented to have its axes parallel to walls of the building 145. However, this orientation is not required. For example, the axes can be at any orientation relative to the building 145. Moreover, the origin can be located at any position.

While FIG. 1 depicts two-dimensional coordinate systems, the present invention is not so limited. Embodiments of the present invention are well suited to one- or three-dimensions.

Embodiments of the present invention make use of a mobile electronic device that is able to communicate with other devices to determine its position in a local coordinate system. In FIG. 1, mobile device 125 is a mobile device that is able to communicate with a position determining system 135 comprising fixed devices 135a-c to learn the local coordinates of mobile device 125. Thus, fixed devices 135a-c are devices for which local coordinates are known. Preferably, fixed devices 135a-c are not arranged in a straight line with each other. The local coordinate of the mobile device 125 can be learned by measuring the distance between mobile device 125 and each of fixed devices 135a-c. Given that the local coordinate are known for fixed devices 135a-c, position determining system 135 may utilize a technique such as triangulation to determine the local coordinate for mobile device 125. It will be understood that the present invention is not to be limited to any particular technique for determining the local coordinate of the mobile device 125. The mobile device 125 may communicate with the backend computing device 149, which may implement portions of embodiments of the present invention. However, the backend computing device 149 is not a requirement of the present invention.

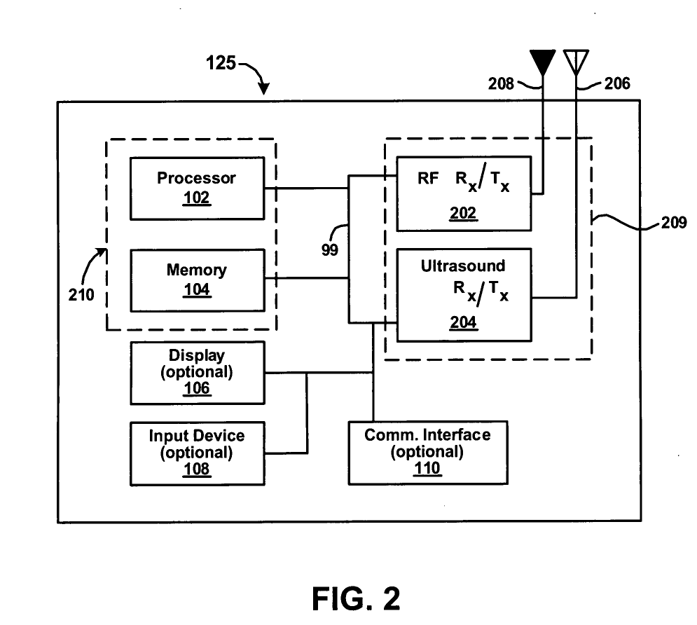

FIG. 2 illustrates an exemplary mobile device 125, in accordance with an embodiment of the present invention. The exemplary mobile device 125 has a radio frequency (RF) receiver/transmitter 202 and an ultrasound receiver/transmitter 204. In one embodiment, to determine a distance between the mobile device 125 and one or all of the fixed devices 135a-c, the mobile device 125 simultaneously transmits an RF signal and an ultrasound signal. The receiving fixed device (e.g., 135a) notes the time difference between the reception of the RF signal and the ultrasound signal to determine the distance between the nodes. However, the transmission of the RF and ultrasound signal do not have to be simultaneous. The distance can also be measured by the fixed device 135 transmitting the signals with the mobile device 125 receiving. Moreover, the distance between devices may be determined in any convenient fashion, and thus the distance measuring technique is not limited to using an RF and/or an ultrasound signal.

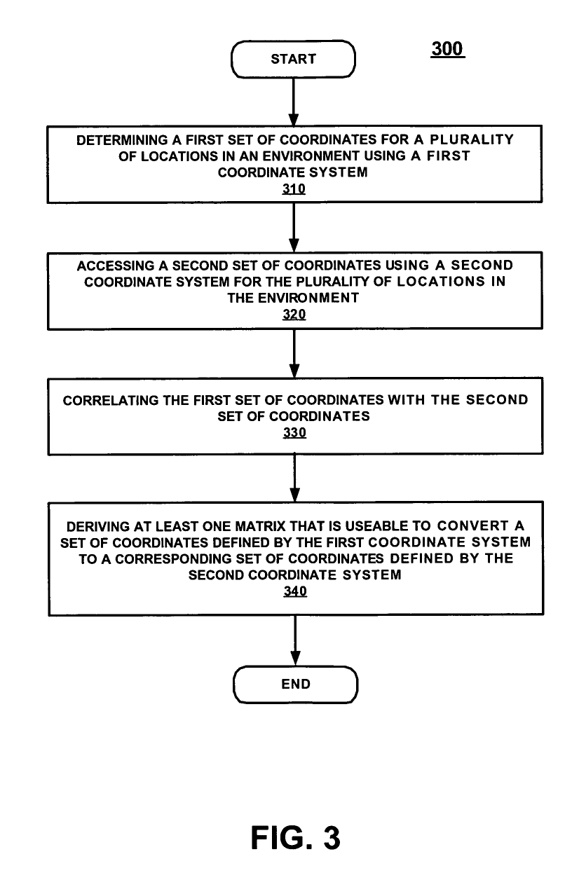

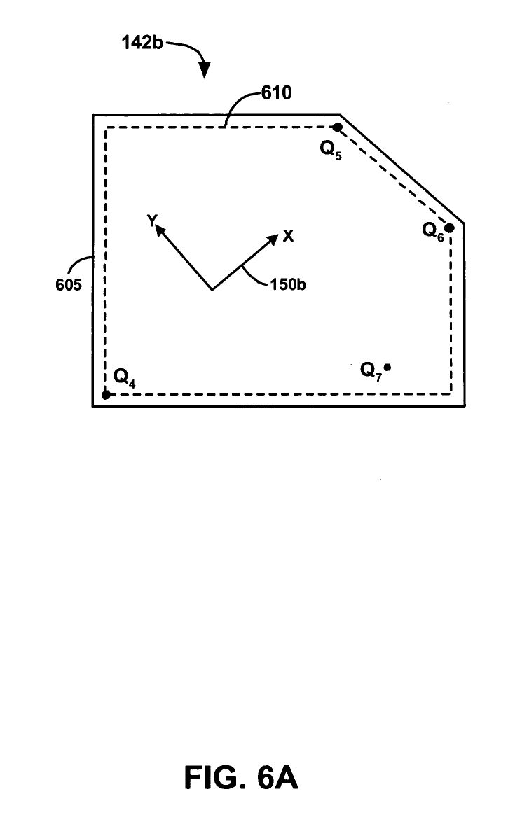

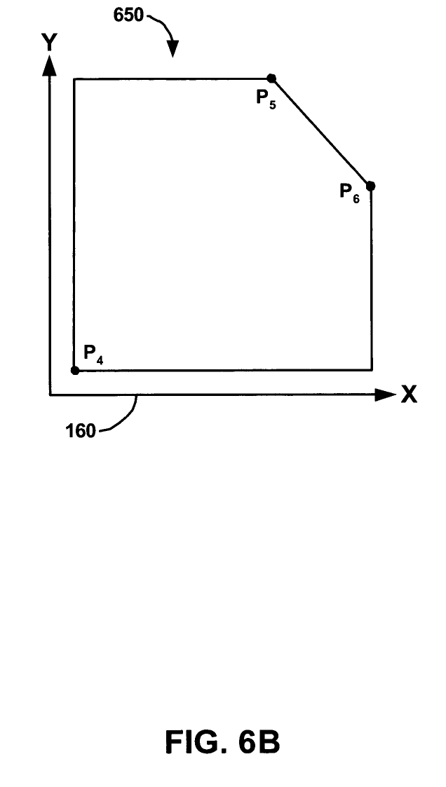

The exemplary mobile device 125 also has a processor 102 and computer readable memory 104 coupled to a bus 99. Embodiments of the present invention store software instructions on the computer readable medium 104, which when executed on the processor 102 implement embodiments in accordance with the present invention. For example, some or all of the steps of process 300 of FIG. 3 and process 600 of FIG. 6 may be executed on processor 102.

The mobile device 125 has an optional display, which may be used to depict a map of a room. The display is sensitive to a portion of the display being selected, in one embodiment, such that a location on a map depicted on the display may be identified. The mobile device 125 may also have an input device 108, such as, for example, a keypad. The mobile device 125 may also optionally have a communication interface 110, such as, for example, a serial data interface or a parallel data interface.

### Symmetric Environment Embodiment

For convenience of explanation, embodiments of the present invention will be discussed with reference to a “landmark-based embodiment” and a “perimeter-based embodiment.” The term “landmark-based embodiment” refers to a method in which the local and/or common coordinates of a plurality of discreet locations or landmarks within a mapped environment are determined. Typically, the discreet locations have been previously defined with reference to the common coordinate system before being mapped using the local coordinate system. For example, determining the local and/or common coordinates of a door and four corners of a room may be defined as a landmark-based method in accordance with embodiments of the present invention. However, embodiments of the present invention are not limited to collecting the local and/or common coordinates of these locations alone.

The term “perimeter-based embodiment” refers to a method in which local and/or common coordinates of at least some locations of a mapped environment pertain to the shape of the environment being mapped. Again, some of these locations may be previously defined using the common coordinate system prior to being mapped by the local coordinate system. For example, a user could walk the perimeter of a room and collect measurements of the room perimeter using an electronic device. It is not required that the measurements are entirely continuous. For example, the user could collect local and/or common coordinates of portions of some or all of the walls of a room or collect the coordinates periodically (e.g., every second) while walking the perimeter of the room.

Embodiments of the present invention may be used to map a non-symmetric environment, or a symmetric environment. Due to its shape, a symmetric environment (e.g., a square room, a round room, etc.) does not necessarily imply the orientation of the symmetric environment with reference to the building as a whole. For example, a round room does not readily imply its orientation to a building based upon the shape of the room itself. As a result, when mapping a symmetric environment, it may be difficult correlate the local coordinate system with the common coordinate system. Accordingly, embodiments of the present invention utilize a landmark method to determine the local coordinates of the symmetric environment.

An overview of one embodiment of the present invention is as follows. A map of an environment is provided on a mobile device. Initially, it may be known how the map correlates to the common coordinate system (e.g., common coordinate system 160 of FIG. 1), but not the local coordinate system (e.g., local coordinate system 150a of FIG. 1). A user takes the mobile device to a known location in the room (e.g., door 157a of FIG. 1), which may be an arbitrary location or a location specified to the user. The user indicates the device's location on the provided map when in proximity to the known location. In response to this indication, the device's coordinates in the local coordinate system (e.g., 150a) are determined while the device is at the known location. The local coordinates are then correlated to the common coordinates.

The user then takes the mobile device to additional locations in the room (e.g., points 157b and 157c of FIG. 1), wherein other local coordinates are determined and matched to their corresponding common coordinates. Then, based on the matched coordinates, one or more matrices are determined that are suitable to convert any arbitrary set of coordinates in the local coordinate system to its corresponding set of coordinates in the common coordinate system. Additionally, one or more matrices may be determined that are suitable to convert any arbitrary set of coordinates in the common coordinate system to its corresponding set of coordinates in the local coordinate system.

This embodiment will be further discussed in conjunction with the process 300 depicted in FIG. 3 and the diagram of FIG. 1. To explain this embodiment, an example is given in which the local coordinate system for room 142a is correlated to a common coordinate system 160 for the building of FIG. 1. However, it will be understood that the conversion may be between any two coordinate systems. For example, the conversion could be between two local coordinate systems (e.g., 150a and 150b).

This process 300 involves steps that may be stored as instructions on a computer readable medium and executed on a processor. In one embodiment, a single computing device, such as the mobile device 125 carries out all of the steps of the process 300. However, in another embodiment, the process 300 involves a second computing device, such as back-end computing device 149.

In step 310 of process 300, a first set of coordinates for a plurality of locations in an environment (e.g., room 142a of FIG. 1) are determined using a first coordinate system. In embodiments of the present invention, the first set of coordinates are defined using a position determining system which uses a first coordinate system. For example, a user can use mobile device 125 to determine a set of coordinates for a plurality of locations in room 142a. In embodiments of the present invention, the set of coordinates are defined by position determining system 135 which uses local coordinate system 150a to define locations within room 142a. Thus, the user can determine a set of coordinates using mobile device 125 when the user is proximate to the door (e.g., location 157a).

In embodiments of the present invention, the user indicates with mobile device 125 when proximate to location 157a. In response, position determining system 135 determines the position of location 157a with reference to local coordinate system 150a (e.g., by triangulating the position of mobile device 125 using fixed devices 135a-135c). The user then moves to each of the windows (e.g., locations 157b and 157c) and repeats this process to determine the set of coordinates for each of these locations. In embodiments of the present invention, the user is instructed to go to each of these discreet locations in order to determine the position of these locations with reference to coordinate system 150a.

For example, a map of room 142a is displayed on the mobile computing device 125 via its display screen. The map allows a user to identify the position of the mobile device in a later step of process 300. Coordinates in the common coordinate system are known for at least portions of the map. The map may be displayed in accordance with any suitable technique. The technique for constructing the map is not critical to the present invention.

However, it is not required that a map be displayed for a user to be able to identify a location. For example, the user may be directed to “go to the door.” Or the user can be directed to go to a location from a list of locations. For example, a text window can be displayed with locations, “window,” “door,” and “thermostat.”

In embodiments of the present invention, step 310 involves receiving an indication that a portion of the displayed map was selected. For example, a user goes to location 157a (FIG. 1) of the environment and indicates that location on the provided map. The user may go to any arbitrary location, in one implementation. In one implementation, the user receives a description of the symmetric environment in which the plurality of locations is a previously defined discreet location. For example, the user could receive a list of locations (e.g., door, window 1, window 2, etc.), or a map showing the plurality of locations. It will be understood that it is not required that the location identifies where local coordinates will be collected. This location is not necessarily the location of the user or even the device used to input the location. For example, separate devices may be used to input the location and collect local coordinates for the location.

In one embodiment, the display screen (e.g., display 106 of FIG. 2) is capable of sensing what portion of the display screen is touched. For example, the user touches with a stylus or fingertip the portion of the screen corresponding to the location. However, this is just one example of identifying the location. The user could also identify location by selecting text or a graphical icon with, for example, a cursor. Alternatively, the user could type in or even speak a location identifier.

As previously mentioned, it is not required that a map be displayed to the user. In one implementation, the user goes to one of several locations that are identified to the user. For example, the display screen could identify a location by indicating “door” or “window.” Once at a location, the user indicates the location by any convenient technique. However, it will be understood that these techniques are not the only way to receive an indicator of a location in the environment.

The local coordinates may be accessed by a mobile device communicating with other devices in the room to determine the mobile device's coordinates within the local coordinate system. However, the local coordinate may be determined in any convenient fashion. It will be understood that it is not required that the device whose location is determined to arrive at the local coordinates is necessarily the same device that is used to indicate the location. For example, a first device can be placed at a desired location, whereas a second device can be used to identify the location.

In embodiments of the present invention, step 310 may be repeated to allow additional local coordinates to be determined. In one embodiment, a minimum of three matching pairs of coordinates are determined. In another embodiment, the user goes to up to six unique locations, wherein up to six matching pairs of coordinates are determined.

In step 320 of process 300, a second set of coordinates for the plurality of locations in the environment are accessed. In embodiments of the present invention, the second set of coordinates are defined by a second coordinate system. In embodiments of the present invention, the second set of coordinates are previously defined discreet locations. As described above with reference to step 310, in embodiments of the present invention, the user of mobile device 125 may be instructed to go to previously defined locations (e.g., locations 157a-157c) to determine the position of these locations with reference to the local coordinate system 150a of symmetric environment 142a. In embodiments of the present invention, the position of these locations (e.g., locations 157a-157c) is already previously defined with reference to the common coordinate system 160.

As previously discussed, common coordinates for at least portions of the map are known. Thus, by identifying a portion of the map or the like to which mobile device 125 is proximate, the common coordinate can be determined. However, as also has been previously mentioned, it is not required that a map be displayed. For example, in one embodiment, the user is instructed to “go to the door.” Common coordinates may also be known for specifically locations such as “door,” “window,” “thermostat.” The user may also indicate position by such an identifier.

In step 330 of process 300, the first set of coordinates are correlated with the second set of coordinates. That is, the local and common coordinates are identified as being corresponding coordinates in the two coordinate systems. In embodiments of the present invention, correlation of the first set of coordinates with the second set of coordinates is facilitated because the

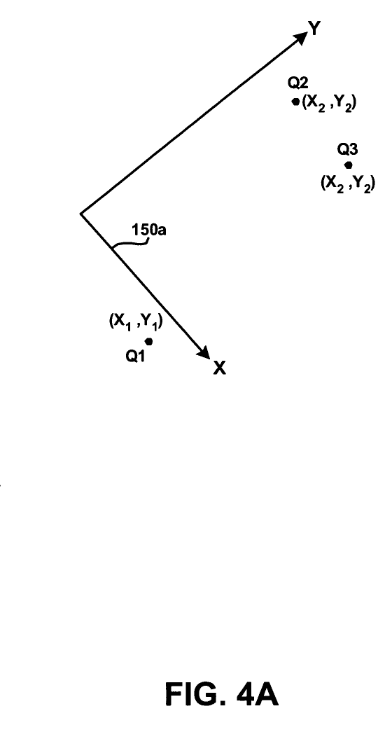

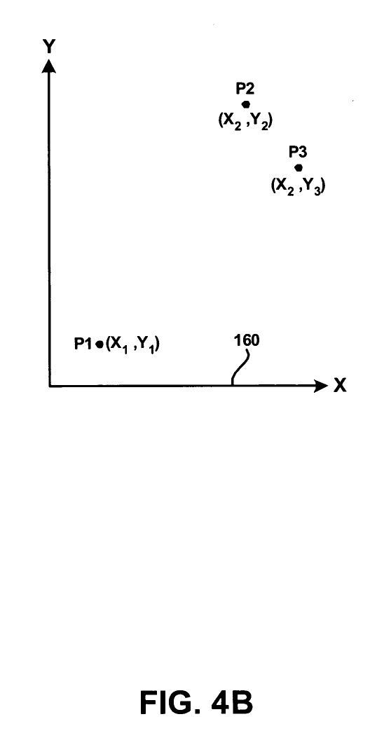

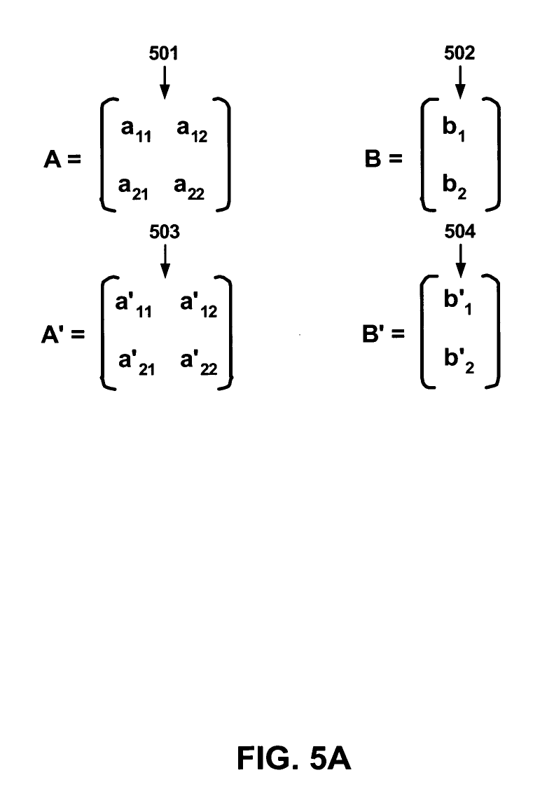

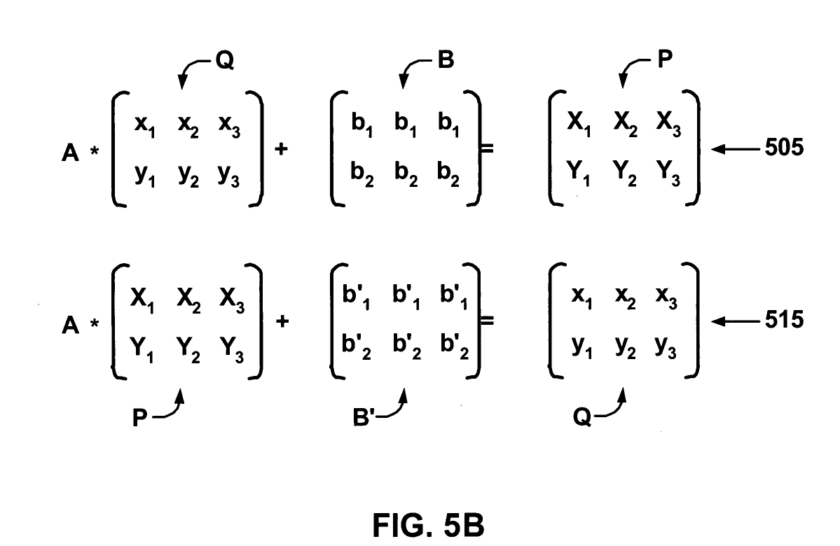

In step 340 of process 300, at least one matrix is derived that is useable to convert a set of coordinates defined by the first coordinates system to a corresponding set of coordinates defined by the second coordinates system. For example, the matrix can be used in a process to convert from the common coordinate system to the local coordinate system. Step 340 may comprise determining a rotation matrix and a translation matrix, as will be described herein with reference to FIGS. 4A, 4B, 5A, and 5B. More coordinates can be collected after the matrix (or matrices) is determined. If additional data points are received, steps 310-330 can be repeated after performing step 340. In this case, the matrix is re-calculated with the new data.

In embodiments of the present invention, a second matrix (or matrices) is determined that is complimentary to the matrix of step 340. This may comprise determining a rotation matrix and a translation matrix, as will be described herein. In embodiments of the present invention, the second matrices are able to convert coordinates from the local coordinate system to corresponding common coordinates.

Referring now to FIG. 4A, FIG. 4B, FIG. 5A, and FIG. 5B, details of determining the matrices in accordance with an embodiment of the present invention are discussed. FIG. 4A illustrates a representation of a first coordinate system that for purposes of illustration is referred to as a local coordinate system. In FIG. 4A, the local coordinate system 150a from FIG. 1 is represented. However, the present invention is not so limited. Three points in the local coordinate system 150a are depicted: Q1, Q2, and Q3.

FIG. 4B illustrates a representation of a second coordinate system that for purposes of illustration is referred to as a common coordinate system 160. As an example, a back-end computing device 149 may use the common coordinate system 160. However, the present invention is not so limited. Three points in the common coordinate system 160 are depicted: P1, P2, and P3. These three points P1, P2, P3 in the common coordinate system 160 are meant to represent the same physical location as points Q1, Q2, and Q3, respectively, in the local coordinate system 150a.

Because the common coordinate system 160 and the local coordinate system 150a are bijective, there exist four unique matrices that may be used to translate between the two coordinate systems. The four matrices can be determined based on three non-aligned points. For example, the points P1/Q1, P2/Q2, and P3/Q3 will suffice as three non-aligned points.

The four matrices will be referred to as A, B, A′, and B′, wherein A is a translation matrix and B is a rotation matrix used to convert from the local coordinate system to the common coordinate system. A′ is a translation matrix and B′ is a rotation matrix used to convert from the common coordinate system to the local coordinate system. The four matrices are depicted in FIG. 5A (501-504).

To determine the matrices A, A′, B, and B′ the two systems depicted in FIG. 5B are resolved. In FIG. 5B, system 505 is indicated in Equation and system 515 is indicated in Equation 2.
A*Q+B=P Equation 1:
A′*P+B′=Q Equation 2:

The matrix Q comprises the points Q1, Q2, and Q3 from FIG. 4A and the matrix P comprises the points P1, P2, P3 from FIG. 4B. Resolving the two systems in FIG. 5B to provide A, A′, B, and B′ is known to those of ordinary skill in the art. Once the four unique matrices are known, it is possible to convert any point from one of the coordinate systems to the other coordinate system. While the technique illustrated in FIGS. 4A, 4B, 5A, and 5B are suited to determine the conversion matrices, it will be understood that the details of determining the conversion matrices once the data is collected is not critical.

### Non-symmetric Environment Embodiment

Another embodiment of the present invention is a method of converting between two coordinate systems, in which an asymmetric region is used to collect data to be used in determining one or more conversion matrices. For example, data may be collected along the perimeter of a room that has a non-symmetric shape. However, it is also possible that the room itself is symmetrical, but a non-symmetric region within the room is defined. The non-symmetric environment is typically within the room, but there is no reason why it must be within the bounds of the room.

Referring to the rooms in FIG. 1, rooms 142a and 142d are substantially symmetrical. However, rooms 142b and 142c are non-symmetric environments. In a two-dimensional case, an environment is symmetrical if there is symmetry with respect to any axis in the plane defined by the two-dimensional coordinate system. Otherwise, it is defined as a non-symmetric environment.

Referring again to process 300 of FIG. 3, FIG. 6A, and diagram 650 in FIG. 6B, an embodiment of the present invention using a non-symmetric environment for data collection will be discussed.

In step 310 of process 300, a first set of coordinates for a plurality of locations in an environment (e.g., room 142b of FIG. 1) are determined using a first coordinate system. In one implementation, the user receives a description of the non-symmetric environment in which at least some of the plurality of locations are previously defined discreet locations which pertain to the shape of the non-symmetric environment. For example, referring to FIG. 6A, a user walks substantially close to the non-symmetric environment 610 while holding a device that is able to learn its local coordinates. It will be understood that the region that the user traverses does not have to exactly match or pertain to the shape of the non-symmetric environment 610. The non-symmetric environment 610 in this case is proximate walls 605 of the room 142b. However, this is not required.

To learn its coordinates, the mobile device 125 which the user holds may communicate with other devices in the room 142b.The number of local coordinates that are collected is sufficient to understand the shape of the environment with whatever certainty is desired. That is, as a practical matter local coordinates are collected at a number of locations along the non-symmetric environment 610. Thus, extrapolation may be used to fill between collected local coordinates. The rate at which local coordinates are collected can be set based on an expected traversal rate and pre-known shapes of various non-symmetric environments that may be used. Moreover, it is not required that the user traverse exactly along the pre-determined non-symmetric environment 610. In another embodiment, the user can determine the local coordinates at previously defined discreet locations in non-symmetric environment 610 as described above with reference to FIG. 3.

In another implementation, the user receives a description of the non-symmetric environment in which each of the plurality of locations is a previously defined discreet location. For example, the user could receive a list of locations (e.g., door, window 1, window 2, etc.), or a map showing the plurality of locations. It will be understood that it is not required that the location identifies where local coordinates will be collected. This location is not necessarily the location of the user or even the device used to input the location.

In embodiments of the present invention, a determination may be made whether more local coordinates are to be collected. Any convenient technique may be used to determine that data collection is done, such as receiving an indication from the user that the user has finished traversing the non-symmetric environment 610. Further, it will be understood that it is not required that every point of the pre-determined non-symmetric environment region 610 needs to be traversed by the user.

In step 320 of process 300, a second set of coordinates for a plurality of locations in the environment are accessed. In the present embodiment, a description of the non-symmetric environment is accessed. The description 650 of the non-symmetric environment is depicted in FIG. 6B, which relates the description to the common coordinate system 160. Thus, points in the common coordinate system 160 are known for various points of the description 650. The correct description can be identified in a variety of ways. In one implementation, a user identifies what environment (e.g., room) the user is in, such that a computing device accesses the description for that environment. In some cases, it is not necessary for the user to identify that room, however. For example, based on the shape of the non-symmetric environment, as defined by the local coordinates, the identity of the room can in some cases be uniquely identified by correlating the collected data to descriptions of room shapes stored in a database.

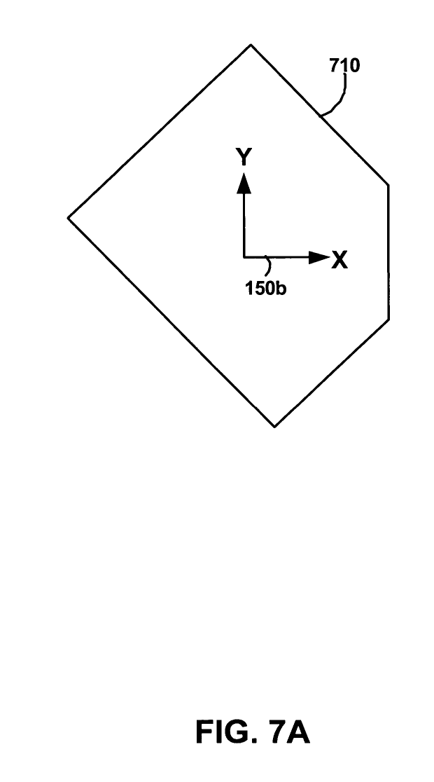

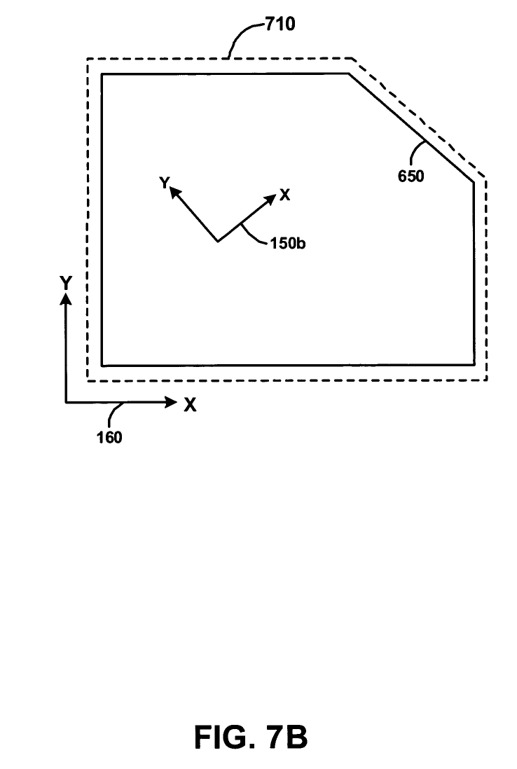

In step 330 of process 300, the first set of coordinates are correlated with the second set of coordinates. In step 330, the collected local coordinates are analyzed to orient and translate the local coordinate system to the common coordinate system. Since the pre-determined region is a non-symmetric environment, the orientation can be uniquely determined. FIG. 7A illustrates the local coordinate system 150b and a shape 710 that has been determined based on the collected local coordinates. In FIG. 7B, the local coordinate system 150b has been oriented relative to the common coordinate system 160 based on the shape 710 defined by the collected local coordinates and the shape of the pre-determined non-symmetric environment 650 that has been already related to the common coordinate system 160. The orientation effectively defines the origin and axis of the local coordinate system 150b within the common coordinate system 160.

In step 340 of process 300, at least one matrix is derived that is useable to convert a set of coordinates defined by the first coordinates system to a corresponding set of coordinates defined by the second coordinates system. Once the local coordinate system 150b has been oriented relative the common coordinate system 160, the matrices that can be used to convert between the local and common coordinate system are determined. Step 340 may proceed in a similar fashion as the determination of the matrix in step 340 of process 300 in FIG. 3. However, the present invention is not limited to applying this technique in step 340 of process 300.

Thus, in one embodiment, a unique mapping of the collected local coordinates is made to the common coordinates. For example, points Q4, Q5, and Q6 in the local coordinate system in FIG. 6A are mapped to points P4, P5, and P6, respectively, in the common coordinate system in FIG. 6B. Any convenient three points may be selected, so long as they do not form a straight line. Based on the mapping of the points, one or mode matrices are determined that are useable to convert local coordinates to corresponding global coordinates.

It will be understood that it is not required that the collected data points be on the pre-determined non-symmetric environment 610. For example, point Q7 in FIG. 6A is not on the non-symmetric environment 610. However, since the shape of the non-symmetric environment 610 is known, adjustments can be made to the collected local coordinates to compensate for deviations that the user made from an exact traversal of the pre-determined non-symmetric environment 610.

However, given that the location of the origin and orientation of the axes of the local coordinate system within the common coordinate system is known, step 640 is not necessarily required to proceed as above. As FIG. 7A and FIG. 7B illustrate, the necessary rotation and translation factors to convert from one coordinate system to the other can be derived from the relationship between the origins and orientation of axes of the two coordinate systems.

While the present invention has been described in particular embodiments, it should be appreciated that the present invention should not be construed as limited by such embodiments, but rather construed according to the below claims.

What is claimed is:

1. A method for converting between coordinate systems, said method comprising:
determining a first set of coordinates for a plurality of locations in an environment using a first coordinate system, said first set of coordinates obtained by moving a mobile device to at least three locations in said environment wherein said at least three locations are defined by a position determining system comprising a plurality of fixed devices disposed in said environment;
accessing a second set of coordinates for said plurality of locations in said environment, and wherein said second set of coordinates are defined by a second coordinate system;
correlating said first set of coordinates with said second set of coordinates; and
deriving at least one matrix that is useable to convert a set of coordinates defined by the first coordinate system to a corresponding set of coordinates defined by said second coordinate system.

2. The method as recited in claim 1 wherein said environment comprises a non-symmetric environment.

3. The method as recited in claim 2 further comprising:
receiving a description of said non-symmetric environment and wherein each of said plurality of locations is a previously defined discreet location; and
determining the coordinates of each of said plurality of discreet locations using said first coordinate system.

4. The method as recited in claim 2 further comprising:
receiving a description of said non-symmetric environment and wherein at least some of said plurality of locations pertain to the shape of said non-symmetric environment; and
determining the coordinates of said plurality of locations using said first coordinate system.

5. The method as recited in claim 1 wherein said environment comprises a symmetric environment.

6. The method as recited in claim 5 further comprising:
receiving a description of said symmetric environment and wherein each of said plurality of locations is a previously defined discreet location; and
determining the coordinates of each of said plurality of discreet locations using said first coordinate system.

7. The method as recited in claim 1 wherein said deriving comprises:
deriving a rotation matrix and a translation matrix.

8. A computer usable medium having computer readable program code embodied therein for causing a computer system to perform a method for converting between coordinate systems, said method comprising:
determining a first set of coordinates for a plurality of locations in an environment using a first coordinate system, said first set of coordinates obtained by moving a mobile device to at least three locations in said environment wherein said at least three locations are defined by a position determining system comprising a plurality of fixed devices disposed in said environment;
accessing a second set of coordinates for said plurality of locations in said symmetric environment, and wherein said second set of coordinates are defined by a second coordinate system;
correlating said first set of coordinates with said second set of coordinates; and
deriving at least one matrix that is useable to convert a set of coordinates defined by the first coordinate system to a corresponding set of coordinates defined by said second coordinate system.

9. The computer usable medium of claim 8 wherein said environment comprises a non-symmetric environment.

10. The computer usable medium of claim 9 wherein said method further comprises:
receiving a description of said non-symmetric environment and wherein each of said plurality of locations is a previously defined discreet location; and
determining the coordinates of each of said plurality of discreet locations using said first coordinate system.

11. The computer usable medium of claim 9 wherein said method further comprises:
receiving a description of said non-symmetric environment and wherein at least some of said plurality of locations pertain to the shape of said non-symmetric environment; and
determining the coordinates of said plurality of locations using said first coordinate system.

12. The computer usable medium of claim 8 wherein said environment comprises a symmetric environment and wherein said method further comprises:
receiving a description of said symmetric environment and wherein each of said plurality of locations is a previously defined discreet location; and
determining the coordinates of each of said plurality of discreet locations using said first coordinate system.

13. The computer usable medium of claim 8 wherein said deriving comprises:
deriving a rotation matrix and a translation matrix.

14. A system for converting between coordinate systems, said system comprising:
a processing unit for performing a method for converting between coordinate systems, said method comprising:
correlating a first set of coordinates for a plurality of locations in an environment with a second set of coordinates for said plurality of locations, and wherein said first set of coordinates are defined by a position determining system using a first coordinate system comprising a plurality of fixed devices disposed in said environment and said second set of coordinates are defined by a second coordinate system; and
deriving at least one matrix that is useable to convert a set of coordinates defined by the first coordinate system to a corresponding set of coordinates defined by said second coordinate system;
a mobile device for initiating the determination of said first set of coordinates; and
a plurality of position devices for determining said first set of coordinates.

15. The system of claim 14 wherein said environment comprises a non-symmetric environment.

16. The system of claim 15 wherein said method further comprises:
receiving a description of said non-symmetric environment and wherein each of said plurality of locations is a previously defined discreet location; and
determining the coordinates of each of said plurality of discreet locations using said first coordinate system.

17. The system of claim 14 wherein said environment comprises a symmetric environment.

18. The system of claim 17 wherein said method further comprises:
receiving a description of said non-symmetric environment and wherein at least some of said plurality of locations pertain to the shape of said non-symmetric environment; and
determining the coordinates of said plurality of locations using said first coordinate system.

19. The system of claim 14 wherein said mobile device further comprises a display device for displaying a map wherein each of a plurality of discreet locations of said symmetric environment is displayed and wherein the determination of said first set of coordinates is initiated in response an indication of the proximity of said mobile device to one of said plurality of discreet locations.

20. The system of claim 14 wherein said method further comprises:
deriving a rotation matrix and a translation matrix.
